(19) United States
(12) Patent Application Publication
(10) Pub. No.: US 2026/0062560 A1
(43) Pub. Date: Mar. 5, 2026

(54) THERMAL SPRAY POWDER COATING

(71) Applicant: PPG Industries Ohio, Inc., Cleveland, OH (US)

(72) Inventors: Daniel K. Dei, Monroeville, PA (US); Kathrine Elizabeth Flood, JR., Santa Cruz, CA (US); Brian Kirk Rearick, Allison Park, PA (US); DeAnna Dawn Katz, Gibsonia, PA (US)

(73) Assignee: PPG Industries Ohio, Inc., Cleveland, OH (US)

(21) Appl. No.: 19/106,652

(22) PCT Filed: Jun. 28, 2023
(86) PCT No.: PCT/US2023/069215

§ 371 Date: Feb. 26, 2025

Related U.S. Application Data
(60) Provisional application No. 63/374,420, filed on Sep. 2, 2022.

(51) Int. Cl. C09D 5/03; B05D 1/06; B05D 1/10; B05D 7/00; C09D 5/00; C09D 179/08

(52) U.S. Cl. CPC C09D 5/033; B05D 1/06; B05D 1/10; B05D 7/546; C09D 5/002; C09D 179/08

(57) ABSTRACT

A powder coating composition including a polyamide-imide component comprising from 10 wt. % to 35 wt. % of the powder coating composition; a catalyst; and a carrier component, wherein each of the polyamide-imide component, the catalyst, and the carrier component react to form the powder coating composition.

### CROSS-REFERENCE TO RELATED APPLICATIONS

This application claims the benefit under 35 U.S.C. § 119 (e) of U.S. Provisional Application No. 63/374,420 filed on Sep. 2, 2022 which is incorporated by reference in its entirety.

### STATEMENT REGARDING FEDERALLY SPONSORED RESEARCH OR DEVELOPMENT

This disclosure was made with Government support under Contract Number NCMS 201660 FY2016 Thermal Spray and Powder Application, awarded by The United States Army Combat Capabilities Development Command (DEVCOM) Ground Vehicle Systems Center (GVSC). The United States Government may have certain rights in this disclosure.

### FIELD

The present disclosure relates to powder coating compositions, which include a polyamide-imide component, that can be applied in a thermal spray application process.

### BACKGROUND

Substrates coated with powder coatings are often exposed to harsh conditions, including high salinity environments, such as those present at or near the sea. Extended exposure to high salinity environments can lead to the deterioration of applied coatings. For example, if a coated substrate is exposed to sea spray and/or air that is highly salinated for an extended period, the coating may begin to deteriorate via the salt corrosion, exposing the underlying substrate. The substrate may then be susceptible to deterioration, such as via rusting caused by the high salinity environment, which can compromise the integrity of the underlying substrate.

Additionally, powder coatings are traditionally applied in an electrostatic application process, whereas electrically charged powder particles are attracted to the surfaces of the substrate during powder spraying. This type of powder application process is limited in both substrate type (e.g., requiring an electrically conductive substrate) as well as processing parameters (e.g., indoors, with the ability to electrically charge the powder during application). Furthermore, electrostatic powder coating processes often include post-baking steps, whereas the applied powder coating is baked and cured to form the resulting coating. This may limit the size of the powder coated substrate (e.g., as based upon curing oven dimensional restrictions) and/or the composition of the underlying substrate (e.g., limiting to substrates that can be exposed to high temperatures for extended periods of time).

### SUMMARY

In a first example of the present disclosure, a powder coating composition is described which includes a polyamide-imide component comprising from 10 wt. % to 35 wt. % of the powder coating composition, a catalyst, and a carrier component, wherein each of the polyamide-imide component, the catalyst, and the carrier component react to form the powder coating composition.

In a second example of the present disclosure, a method of preparing a coating composition is provided which includes combining a polyamide-imide component, a catalyst, and a carrier component to form the coating composition, extruding the coating composition at a temperature less than 100° C., and forming a powder of the coating composition.

In a third example of the present disclosure a coated article is provided which includes a substrate, a primer layer applied to the substrate in a spray application process where the primer layer comprises a polyamide-imide component, a phenolic component, a epoxy component, and a catalyst and the polyamide-imide component interacts with each of the phenolic component, the epoxy component, and the catalyst when forming the primer layer, and a topcoat layer applied to the primer layer wherein the primer layer and the topcoat layer bond to form a coating on the article.

### DETAILED DESCRIPTION

The disclosure described herein relates to a powder coating composition which can be applied via either an electrostatic or thermal spray application process, and to a variety of substrates (e.g., both electrically and non-electrically conductive) which exhibits high substrate bonding performance as well as high corrosion resistance. The composition can include at least a polyamide-imide component, that when combined, extruded, and powdered along with the other components of the coating, results in a thermoplastic powder coating layer or a thermoset powder coating layer that can act as either a standalone coating and/or as a primer layer which is compatible with at least a fluoropolymer-based topcoat.

The powder coating composition exhibits many desirable properties including high corrosion resistance, particularly to salt-based corrosion in high salinity environments, high chemical resistance, high substrate bonding performance across a wide variety of substrate types (e.g., electrically and non-electrically conductive surfaces), high coverage performance including high edge to edge and crevice coverage, and high topcoat bonding and adhesion performance if acting as a primer layer, and particularly, acting as a primer layer for fluoropolymer-based topcoats.

In the case where the powder coating composition is applied in a thermal spray application process, the resulting coating also exhibits other desirable properties such as strong adhesion and bonding to both electrically conductive (e.g., metal) and non-electrically conductive (e.g., plastics) substrates, and fast curing and/or setting of the applied powder coating, which in some cases, does not require a post-baking step.

The powder coating composition can be applied as a standalone coating or as a primer layer, where the primer layer can be used in combination with other topcoat layers when forming a coating stackup. In this case, the topcoat layer can be, among other chemistries, fluoropolymer based. This combined primer and topcoat can be high-temperature cured and/or post baked, resulting in a high corrosion and chemically resistant coating stackup.

The powder coating composition applied to the substrate may form a polymeric layer that acts as either a thermoplastic or a thermoset. In this case, the extent of the irreversible reaction(s) that occur between the components of the powder coating composition may result in a powder coating layer that exhibits either thermosetting or thermoplastic behavior. For example, in the case where the components of the powder coating composition react to a relatively low extent (e.g., as based upon one or more of the reactants and/or reactive functional components being present in low amounts, limiting the extent of the reaction(s)), the resulting powder coating layer may not cure, forming a polymeric thermoplastic layer). However, in the case where the components of the powder coating composition react to a relatively high extent (e.g., as based upon the reactants and/or reactive functional components being present in amounts to fully, or nearly fully react with one another) the resulting powder coating layer may cure, forming a polymeric thermoset layer. As such, the powder coating composition described herein may be referred to in either a thermoplastic or a thermoset context.

### I. Definitions:

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The phrase “chemical compatibility” relates to the ability of multiple initial layers to form into a homogenous layer during the curing/gelation process, and/or coalescing of individual particles when forming the film.

The phrase “interact” relates to either, or both of, the physical and chemical interactions between individual components. This may include, but is not limited to, the chemical interactions between the one or more components as well as the physical interaction (e.g., mixing, combining, etc.) between each component.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” pigment, and the like refer to one or more of any of these items.

### II. Powder Coating Composition:

The powder coating composition of the present disclosure can include any one of a epoxy component, a curative component, a polyamide-imide component, an accelerant and/or catalyst, an adhesion promoter, and one or more additional additives (e.g., pigments, a second polymer, etc.). In this case, each of the components may be combined at certain weight percent's, resulting in the described powder coating composition.

The powder coating composition can include both an epoxy component and a curative component. In this case, when the curative component and the epoxy component are combined, the two components chemically interact and/or react, forming a epoxy-curative system/network. The epoxy-curative network/system acts as structure of the powder coating composition, where additional components (e.g., the polyamide-imide component, accelerant/catalyst, adhesion promoters, pigments, etc.) can be added, resulting in a powder coating composition with the previously described physical and chemical characteristics. Specifically, the epoxy component and/or combination of the epoxy component and the curative component may serve as a carrier (e.g., a matrix to convey, disperse, and/or flow) the polyamide-imide component and/or other additives, whereas the inclusion of the polyamide-imide component within the polymeric structure results in the high bonding and corrosion resistant properties as described previously.

The epoxy component may be selected from any number of epoxies, which may be epoxy resins suitable for coating compositions. For instance, the epoxy component may be a bisphenol-based epoxy such as NPES-903 epoxy resin manufactured by Nan Ya Plastics Corporation and/or Novolac epoxy resins. The epoxy component may be a solid, such as a crystalline powder and/or flake, or in some cases, may be a liquid, such as a resin. The epoxy component may comprise as little as 25 wt. %, 30 wt. %, 35 wt. %, 40 wt. %, 41 wt. %, 42 wt. %, 43.0 wt. % 43.1 wt. % 43.2 wt. %, 43.3 wt. %, 43.4 wt. % 43.5 wt. % 44 wt. % 45 wt. %, 46 wt. % of the total weight of the powder coating composition, or as great as 50 wt. %, 55 wt. %, 60 wt. %, or 70 wt. % of the total weight of the powder coating composition, or any range defined using any two of the foregoing values as endpoints such as 25 wt. % to 70 wt. %, 30 wt. % to 60 wt. %, and/or 35 wt. % to 55 wt. % of the total weight of the powder coating composition.

The curative component may be a phenol-based compound, an amine-based compound, a thiol-based compound, and/or an anhydride-base compound, that when combined with the epoxy component, reacts to form a polymeric reaction product. For instance, the curative component may be a phenol-based compound, that when combined with the epoxy component, forms an epoxy-phenolic reaction product. In these scenarios, the curative component aids in the crosslinking of the polymer chain when forming the thermoset/thermoplastic polymeric structure of the coating. The curative component may be a solid, such as a crystalline powder and/or flake, or in some cases, may be a liquid, such as a resin. The curative component can be selected from any number of curative compounds suitable for coating applications such as amine-based curatives, thiol-based curatives, anhydride-based curatives, and/or phenolic-based curatives such as Epikure P-202 resin, manufactured by Hexion. The amount of curative component added may be based upon the amount of epoxy component added to the powder coating composition, such that there is enough curative component present to fully react, or at least partially react, with the epoxy component to form the polymeric reaction product. The curative component may comprise as little as 1 wt. %, 3 wt. %, 5 wt. %, 10 wt. %, 11.0 wt. %, 11.5 wt. %, 11.6 wt. %, 11.7 wt. %, 11.8 wt. %, 11.9 wt. %, 12 wt. %, 13 wt. %, 14 wt. %, or 15 wt. % of the total weight of the powder coating composition, or as much as 20 wt. %, 25 wt. %, 30 wt. %, 35 wt. %, or 45 wt. % of the total weight of the powder coating composition, or any range defined using any two of the foregoing values as endpoints such as 1 wt. % to 45 wt. %, 3 wt. % to 30 wt. %, and/or 10 wt. % to 15 wt. % of the total weight of the powder coating composition.

The powder coating composition can include a polyamide-imide component. The polyamide-imide component may be a thermoplastic semi-crystalline polymer that, when combined with the epoxy resin and curative component, results in a coating composition that exhibits the high-performance characteristics as described previously. Specifically, the polyamide-imide component exhibits high bonding performance, and particularly, high bonding performance when applied to metal surfaces. Traditionally, coatings including polyamide-imide components were limited to liquid application processes (e.g., liquid-based coatings). In this case, the powder coating composition can include the polyamide-imide component as a powder, which exhibits the high chemical and corrosion resistant characteristics which can be applied in thermal spraying and/or electrostatic spraying processes, as will be described in further detail herein. The polyamide-imide component may also exhibit high temperature stability, such that when applied in a thermal-spay application process with the epoxy and curative components as discussed previously, results in a powder coating composition which maintains chemical and physical stability at high temperature ranges.

The polyamide-imide component can be selected from any number of polyamide-imide-containing compounds suitable for coating applications, such as Torlon AI-10 polyamide-imide and/or Torlon 4000TF polyamide-imide resin manufactured by Solvay. The polyamide-imide component may be in a solid form, such as a crystalline powder, or in some cases, may be in liquid form, such as a resin. The polyamide imide component may comprise a relatively high proportion of the total weight of the powder coating composition. For instance, the polyamide-imide component may comprise as little as 5 wt. %, 10 wt. %, 15 wt. %, or 18 wt. % of the total weight of the powder coating composition, or as much as 20 wt. %, 21 wt. %, 22 wt. %, 23 wt. %, 24 wt. %, 24.5 wt. %, 24.6 wt. %, 24.7 wt. %, 24.8 wt. %, 24.9 wt. %, 25.0 wt. %, 25.1 wt. %, 25.2 wt. %, 25.3 wt. %, 25.4 wt. %, 25.5 wt. %, 26 wt. %, 27 wt. %, 28 wt. %, 30 wt. %, 40 wt. %, 45 wt. %, or 50 wt. % of the total weight of the powder coating composition, or any range defined using any two of the foregoing values as endpoints such as 5 wt. % to 50 wt. %, 15 wt. % to 40 wt. %, and/or 20 wt. % to 35 wt. % of the total weight of the powder coating composition.

The polyamide-imide component may be selected based upon the acid number. In some cases, the polyamide-imide component may be selected based upon a relatively low acid number. For instance, the polyamide-imide component can comprise an acid number as low as 5, 10, 15, 20, 25 or as high as 60, 70, or 80, or any range defined using any two of the foregoing values as endpoints such as 5 to 80, 5 to 40, and 5 to 20.

The polyamide-imide component may also be selected based upon the solids content. For instance, the polyamide-imide component can comprise a solids content as low as 60%, 70%, or 80% of the overall composition of the polyamide-imide component, or may be as high as 90%, 91%, 92%, 93%, 94%, 95%, 96%, 97%, 98%, or 99% of the overall composition of the polyamide-imide component, or any range defined using any two of the foregoing values as endpoints such as 80% to 99%, 85% to 99%, or 90% to 99% of the overall composition of the polyamide-imide component.

The polyamide-imide component may also be selected based upon one or more solubility characteristics, such as for solubility within any one of solvents N-Methylpyrrolidone (NMP), dimethylacetamide (DMAc), Dimethylformamide (DMF), and/or Dimethyl sulfoxide (DMSO).

The powder coating composition can include one or more catalyst(s) (i.e., catalysts, activating agents, accelerants, etc.). In this case, the catalyst may interact with and/or react with one or more of the components of the powder coating composition when forming the powder coating. For instance, the catalyst may serve as an activating agent, lowering the curing temperature and/or time required for curing of the applied coating composition. Specifically, the catalyst may react with any one of the epoxy component, the curative component, the epoxy-phenolic reaction product produced by the interaction of the epoxy component and curative component, and/or the polyamide-imide component, lowering the crosslinking energy associated with forming the thermoset/thermoplastic polymer matrix, resulting in a lower curing temperature than if the catalyst were not included in the powder coating composition. In this case, the combination of the polyamide-imide component and the catalyst greatly reduces the curing temperature associated with the thermosetting polymer, allowing for the thermosetting polymer to at least partially cure ambiently (e.g., curing without a post-baking step).

The catalyst can be selected from any number of catalytic compounds suitable for coating applications. For example, the catalyst may be an imidazole-based catalyst such as 2-Methylimidazole (e.g., DYHARD® MI-FF manufactured by AlzChem AG). The catalyst may be in a solid form, or in some cases, may be in a liquid form. The catalyst may comprise a relatively low proportion of the total weight of the powder coating composition. For instance, the catalyst may comprise as little as trace, 0.1 wt. %, 0.2 wt. %, 0.3 wt. %. 0.4 wt. %, or 0.5 wt. % of the total weight of the powder coating composition, or as much as 1 wt. %, 2 wt. %, or 3 wt. % of the total weight of the powder coating composition, or any range defined using any two of the foregoing values as endpoints such as trace amounts to 3 wt. %, 0.1 wt. % to 2 wt. %, 0.3 wt. % to 1 wt. %, or 0.3 wt. % to 3 wt. % of the total weight of the powder coating composition.

The powder coating composition can include one or more adhesion promoters, which enhance the adhesion of the powder coating to a substrate when applied in either a thermal spray or electrostatic spray application process. The adhesion promoter may interact with both the surface of the substrate and one or more components of the powder coating composition when forming the resulting powder coating, which results in a high degree of adhesion between the substrate and the powder coating. For instance, the adhesion promoter may interact with the surface of a bare substrate (e.g., a substrate lacking any other coating/surfacer), such as a bare metal substrate, and further interact with any one of the epoxy component, the curative component, the epoxy-phenolic reaction product of the epoxy and curative components, the catalyst, and/or the polyamide-imide component when applied as a component of the powder coating composition in either a thermal or electrostatic spray application process. The adhesion promoter enhances the adhesion of the resulting powder coating to the substrate, as compared to a powder coating composition which does not include the adhesion promoter. The inclusion of the adhesion promoter results in high bonding performance between the powder coating and the substrate (e.g., a stronger bond), and particularly, high bonding performance when used on bare metallic substrates, which can be useful when the powder coating composition is applied as a primer layer.

The adhesion promoter can be selected from any number of adhesion promoters suitable for coating applications such as an amino-functional adhesion promoter (e.g., Chartwell B 515.1 manufactured by Chartwell International Inc.) and/or Tris(hydroxymethyl)aminomethane. The adhesion promoter may be in a solid form, or in some cases, may be in a liquid form. The adhesion promoter may comprise a relatively low proportion of the total weight of the powder coating composition. For instance, the adhesion promoter may comprise as little as 0.1 wt. %, 0.5 wt. %, 0.6 wt. %, or 0.7 wt. % of the total weight of the powder coating composition, or as much as 1 wt. %, 2 wt. %, or 3 wt. % of the total weight of the powder coating composition, or any range defined using any two of the foregoing values as endpoints such as 0.1 wt. % to 3 wt. %, 0.5 wt. % to 2 wt. %, and/or 0.5 wt. % to 5 wt. % of the total weight of the powder coating composition.

The powder coating composition can include one or more additional additives such as colorants and/or pigments, which results in a powder coating composition with a desired aesthetic. For instance, one or more pigments/colorants can be added to the powder coating composition to result in a grey appearance when applied in either an electrostatic or thermal application process.

The pigments/colorants can be selected from any number of color-imparting compounds suitable for coating applications resulting in the desired aesthetic. For instance, the pigment/colorant may be titanium dioxide (e.g., commercially available from Sigma-Aldrich) and/or carbon black pigment (e.g., commercially available from Cabot Corporation). The pigment(s)/colorant(s) may be in a solid form, or in some cases, may be in liquid form. The colorant/pigments may comprise a relatively low proportion of the total weight of the powder coating composition. For instance, each colorant/pigment may comprise as little as 0.3 wt. %, 0.4 wt. %, 0.5 wt. %, 0.6 wt. %, 0.7 wt. %, or 0.8 wt. % of the total weight of the powder coating composition, or as much as 10 wt. %, 15 wt. %, 20 wt. %, 25 wt. %, 30 wt. %, 35 wt. %, or 40 wt. % of the total weight of the powder coating composition, or any range defined using any two of the foregoing values as endpoints such as 0.1 wt. % to 0.4 wt. %, 0.8 wt. % to 2 wt. %, 5 wt. % to 40 wt. %, or 10 wt. % to 30 wt. % of the total weight of the powder coating composition.

The powder coating composition can optionally also include one or more additional thermoplastic materials. In this case, the one or more additional thermoplastic materials may impart certain characteristics to the powder coating composition, which may be based upon the type of process used to apply the powder coating. For example, an additional thermoplastic material can be added to enhance one, or any combination of, the thermal stability, corrosion resistant performance, and/or curing rheology of the powder coating composition.

The additional thermoplastic materials can be selected from any number of thermoplastic compounds suitable for coating applications such as polyurethanes, additional polyamides, polyethers, polyetherimides, polysiloxanes, polyether ether ketones, polyimides, polysulfones, polyethersulfones, polyphenylene sulfides (PPS), and/or any copolymer of such compounds. The thermoplastic material may be in a solid form, or in some cases, may be in liquid form. The additional thermoplastic material(s) may optionally comprise as little as 2 wt. %, 3, wt. %, 5 wt. %, 6 wt. %, or 7 wt. % of the total weight of the powder coating composition, or as much as 20 wt. %, 30 wt. %, 35 wt. %, or 40 wt. % of the total weight of the powder coating composition, or any range defined using any two of the foregoing values as endpoints such as between 2 wt. % and 40 wt. %, 5 wt. % and 30 wt. %, or 10 wt. % and 20 wt. % of the total weight of the powder coating composition.

In each of the foregoing cases, the powder coating composition may be blended with one or more additional thermoplastic coating compositions, resulting in a thermoplastic coating blend, and/or metallic coatings, resulting in a metallic thermoplastic coating blend.

### III. Powder Coating Production:

Each of the previously described components of the powder coating composition may be combined, formed into a powder, and subsequently applied to a substrate in either a thermal spray or electrostatic spraying application process. In this case, the components of the powder coating composition may be combined and processed in a specific way, which results in the beneficial performance characteristics as described previously.

Each of the components of the powder coating composition may firstly be combined in a bulk mixing process, whereas each of the components are thoroughly dispersed throughout the mixture. In this case, each of the components may be added to the mixing process in a dry state, a semi-dry state, and/or a liquid state.

Once the components are thoroughly mixed, the powder coating mixture may be heated and extruded in separate and/or combined heating extrusion processes. In the case of a combined heating extrusion process, a screw-type extruder (e.g., a twin-screw extruder) can be used, which may include multiple heating zones that progressively heats the components of the powder coating mixture to a desired temperature. The desired temperature may be based upon the softening and/or melting temperature of any one of the components of the powder coating composition, which upon softening and/or melting may interact and/or react with the other components of the powder coating mixture to result in a powder coating material. For instance, the extruder may include four different heating zones, where the first heating zone heats the powder coating mixture to 50° C. to 70° C., softening the mixture, and each of the second, third, and fourth zones heat the softened mixture to 60° C. to 90° C., holding the mixture at the desired temperature for a given resonance time. In this case, the 60° C. to 90° C. may be the temperature where the epoxy component and curative component begin to react to at least partially form the epoxy phenolic reaction product (e.g., at least partially crosslinking/curing to form the polymeric backbone for the thermoplastic/thermoset material). The 60° C. to 90° C. temperature may also be the activation temperature for any one of the other components of the powder coating composition to begin reacting. Importantly, the 60° C. to 90° C. temperature may also be below the temperature at which thermal decomposition of other components of the powder coating composition occurs, such as below the thermal decomposition temperature of the acid of the polyamide-imide component. Extruding the powder coating composition at this relatively low temperature preserves the reactive functionality of the powder coating composition (e.g., the reactive functionality of at least the acid of the polyamide-imide component).

Although described as relating to 60° C. to 90° C. extrusion temperatures, any other suitable temperatures may be used that maintain the reactive functionality of the powder coating composition once extruded. For instance, rather than being heated to 60° C. to 80° C. as the initial temperature and subsequently heated to and held at 70° C. to 90° C., the powder coating material may be initially heated to anywhere from 40° C. to 100° C., and subsequently heated to anywhere from 50° C. to 150° C. These temperatures may be selectable and/or tunable based upon multiple variables, such as the included components of the powder coating composition (e.g., single thermoplastic materials, multiple thermoplastic materials, metal blends, etc.), the relative amounts of the components of the powder coating composition, and/or the desired application process used to apply the powder coating (e.g., thermal spraying vs. electrostatic spraying). Additionally, the rate that the polymeric material is heated (e.g., the rate at which the powder coating material is fed to the extruder) can be tuned to hold the material at the desired temperatures for adjustable amounts of time, which can further be adjusted based upon any one of the previously described characteristics.

Once heated and extruded, the polymeric powder coating material may be cooled to a desired temperature, resulting in solid cooled particles (e.g., chips, flakes, granules, etc.). The cooled composition may be considered at least partially cured. Once cooled, the solid particles may have a diameter greater than desired for powder coating applications, and thereafter, the size of the solid powder coating material may be reduced, such as by a pulverization process. Once the particle size is reduced, the particles may be milled to a desired particle size diameter, such as milled via an air milling process (e.g., a Mikro ACM®-1 Air Classifying Mill) with a desired mesh, resulting in a targeted powdered particle diameter size distribution. For instance, the powder coating material may be milled with/classified with a mesh anywhere from 50 mesh to 1000 mesh, resulting in an average particles size (e.g., a D97 value) ranging from 300 micron (300 μm) to 10 micron (10 μm), optionally from 50 microns (50 μm) to 10 microns (10 μm), and in some instances, from 40 microns (40 μm) to 20 microns (20 μm). The diameter of the powder coating particle may be tuned based upon a variety of parameters including how the powder coating is applied, such as if the powder coating composition is applied in a thermal application process to a metal substrate, in a thermal application process to a plastic/composite substrate, and/or electrostatically applied to an electrically conductive substrate.

### III. Powder Coating Application Process:

As described previously, the components of the powder coating composition may be combined, heated, and pulverized/milled, resulting in a powdered polymeric material that can be applied in either a thermal and/or electrostatic powder spraying application process.

As relating to electrostatic application of powder coatings, as is known in the art, coating compositions are applied in a powder recovery booth to an electrically conductive substrate, where an electrical charge has been applied to the powder particles therefore attracting the charged powder particles to the surfaces of the substrate. The electrically conductive substrate can be preheated prior to powder application (e.g., to increase the bonding of the powder coating particles to the surface of the substrate) and/or post-baked after the application of the powder (e.g., to initiate the reaction(s) necessary to form a polymeric coating on the substrate).

However, electrostatic application of powder coatings exhibits some limitations, both in substrate type as well as processing parameters. For instance, since an electrical charge is required to attract the powder particles to the surface(s) of the substrate, often the substrate must comprise an electrically conductive material (e.g., a metal or similar electrically conductive material). Furthermore, since the powder particles are sprayed in a powdered state, collection of any non-adhered/over sprayed powder is required. This often necessitates the use of a powder collection booth and associated processing equipment. Additionally, in the case of thermoplastic powder coatings, since the particles are applied to the substrate in a raw powder state, post-baking of the applied powder is often needed to initiate coalescence of the powder coating particles to form the resulting thermoplastic layer on the substrate. This often necessitates the use of curing oven(s). The powder booth equipment and/or the curing oven physical dimensions may also impose size limitations on the substrate (e.g., limited only to a small enough size to fit in the equipment) which often also limits the powder application only to disassembled individual parts (e.g., not being able to be applied to fully constructed components). Finally, in the case where a second layer of a coating is required, the substrate must pass through substantially the same powder coating process for a second time.

As relating to thermal spraying powder coating applications the coating composition is heated to an application temperature which at least partially melts/softens the powder particles in the presence of a carrier gas (e.g., air, inert gas, etc.). In the case of thermoset powder coatings, this initiates the chemical reaction(s) necessary (e.g., crosslinking, partial/full curing, etc.) to form the coating once applied to the substrate. The melted/softened powder particles are accelerated with the gas stream and deposited onto the substrate in a splattering pattern. The resulting coating cures on the substrate which may, but not necessarily, be accomplished in a post baking process (e.g., as based upon the curing requirements of the coating). Subsequent layer(s) of the same, or different, coating formulations can be applied to the first layer to form a multi-layer coating stackup. For instance, the first powder coating composition can be applied as a base/primer layer, and the next layer can be applied on top of the primer layer after the first layer at least partially cures, resulting in a two-layer coating stackup.

Thermal spray powder coating application processes are often more flexible than electrostatic spray applications. For instance, since the thermally sprayed powder is applied in a softened/melted state that self-adheres to the substrate once applied, the coating can be thermal spray applied in the field (e.g., with a mobile spray applicator) which can be to both pre-assembled and disassembled components which do not necessarily need to be electrically conductive. As such, powder collection (e.g., via a powder booth) is often not required since the coating self-adheres to the substrate, and since the melting/softening of the coating components occurs prior to application, post-baking requirements are further alleviated. This increases the flexibility of thermal spray powder coating applications in both the physical dimension (e.g., not being limited by powder booth/oven size limitations) and substrate type (e.g., nonconductive and conductive substrates, as well as to preassembled or disassembled parts).

However, thermal sprayed powder coating performances are typically limited compared to liquid coatings, and particularly, limited relating to high temperature and/or high-performance thermoplastic/thermoset coatings. For instance, in the case of metal substrates, the thermoplastic/thermoset powder coating compositions may exhibit lower adherence, lower corrosion resistance, require post-baking and/or long cure times, and/or be more incompatible with topcoat formulations, as compared to liquid coatings.

As described previously, the present thermally-sprayable powder coating composition exhibits numerous desirable properties including high corrosion resistance, particularly to salt-based corrosion in high salinity environments, high chemical resistance, high substrate bonding performances across a wide variety of substrate types (e.g., electrically and non-electrically conductive surfaces, such as metals, plastics, composite materials, woods, etc.), and particularly high bonding performance to bare metal substrates (e.g., with the inclusion of the adhesion promoter), as well as high coverage performance including high edge to edge and crevice coverage.

The present thermally sprayed powder coating can be applied in the field via a mobile thermal spray application device (e.g., a thermal spray gun) or in a controlled manufacturing environment, to both pre-assembled and assembled parts, which may be to electrically or non-electrically conductive substrates. The powder coating composition may at least partially cure ambiently (e.g., without post baking/curing requirements) and in some cases, requires a relatively low amount of curing time. The thermally sprayed powder coating can be applied in successive layers, where each layer comprises approximately 1 to 5 mils thickness, resulting in a highly impact resistant and durable powder coating layer.

Also as described previously, the present thermally sprayed powder coating is compatible (e.g., chemically and/or physically interactable) with a variety of topcoat formulations, such as topcoat formulations including polyester and/or vinyl components, particularly topcoat formulations containing a fluoropolymer (e.g., polyvinylidene fluoride (PVDF)), and more particularly, topcoat formulations containing an acrylic component in combination with a fluoropolymer.

In these cases, the thermally sprayed powder coating acts as a primer layer, whereas successive layer(s) of the topcoat(s) can be applied to the primer layer, interacting and/or bonding to the primer layer and forming a stack up that includes the thermally sprayed powder coating layer and the topcoat layer including the polyester and/or vinyl-containing compound(s). This stackup may optionally be post-baked and/or cured, where the primer layer exhibits high temperature stability during baking.

Although described relating to thermal spray application, the disclosure herein is not limited only to thermal spraying of the powder coating composition. Rather, the powder coating composition can also be applied via an electrostatic application process to electrically charged conductive substrates in addition to the thermal spray application. Therefore, each of the benefits of the thermally sprayed powder coating equally apply to the application of the powder coating composition in a traditional electrostatic application scenario.

While particular instances of this disclosure have been described above for purposes of illustration, it will be evident to those skilled in the art that numerous variations of the details of the present disclosure may be made without departing from the disclosure as defined in the appended claims.

### Examples

The following Example was prepared by mixing each component of Table 1 in a Prism high speed mixer to form a homogenous mixture. The mixture was passed through a 19 mm twin screw extruder (twin screw extruder supplied by Baker Perkins) utilizing a four-zone temperature profile: zone 1=60° C.; zone 2=80° C.; zone 3=80° C.; zone 4=80° C. The screw speed was set to 500 rpm with an adjusted feed rate such that a torque of 50-60% was achievable. The extrudate was cooled on chill rollers to create solid chips. The solid chips were then pulverized in a Prism high speed mixer and mixed with 0.2 weight percent Aerosil 200 fumed silica. The mixture was ground in an air classifying mill (Mikro ACM®-1 Air Classifying Mill) and passed through a 100 mesh sieve to obtain a powder with approximate average particle sizes (e.g., a DV97 value) of 30 microns.

TABLE 1
Powdered Coating Composition

| Material | Weight % |
|---|---|
| Epoxy component | 35-55 |
| Polyamide-imide component | 20-35 |
| Curative Component (Phenolic) | 10-15 |
| Adhesion promoter | 0.5-1.0 |
| Accelerator | 0.3-0.5 |
| 1^{st} Pigment (TiO2) | 10-30 |
| Black Pigment (Carbon Black) | 0.4-0.8 |

The powder coating composition of Table 1 was thermal spray applied at 180° F. to various metal substrates such as blasted steel and aluminum substrates and iron phosphate treated cold rolled steel panels from ACT. The powder coatings were also capable of electrostatic spray application using a Nordson electrostatic spray gun with a slot or conical tip, followed by baking in an electric or gas oven at 210° C. for 15-20 min.

The physical properties of the applied powder coating composition and the resulting coating were tested according to the methods described herein and are presented in Table 2 below.

Powder Gel Time: The gel time was determined according to the test method described in ASTM D4217-07. The interval at which the coating powder transformed from a dry solid to a gel-like state was measured at 180° C. on a polished hot surface. Measurement of the gel times assures that the powder coating will fully cure as a continuous film when applied.

Gloss: coated panels were evaluated for 200 and 600 specular gloss per ASTM D523-14 using a BYK Micro-Tri-Gloss meter.

Impact resistance: Direct- and reverse-impact resistance on the coating substrates were measured following ASTM D5420-16 using a Gardner impact tester. Impact resistance values, reported as inch-pounds (In.lb), were recorded at the highest level of impact at which no film removal or cracking was observed.

MEK Double Rubs: the extent of cure of each powder coating was assessed by investigating coating chemical resistance. A cotton ball soaked in methyl ethyl ketone (MEK) was rubbed back-and-forth over the coated substrate, and the number of MEK double rubs required to break through or mar the coating was recorded (up to 50 double rubs).

Crosshatch Adhesion: Adhesion of the coatings to metal substrates was evaluated per ASTM D3359-17 Cross-Cut Tape Test. On a scale of OB-5B, a OB rating was assessed if the coating was completely removed using a pressure sensitive tape or 5B if no coating was lifted/removed between ⅛″ cross-hatch scribes.

TABLE 2
Performance of applied Powder Coating Composition:

| | Value | |
|---|---|---|
| | Electrostatic | Thermal Spray |
| Properties | Application | Application |
| Powder Gel Time @ 180° C. (min) | 1:00 | 1:00 |
| Cure [Temp. (° C./Time (min)] | 200/15 | N/A |
| Substrate | Steel, blasted | Steel, blasted |
| | (B-1000) | (B-1000) |
| MEK Double Rub (50 rubs) | No Marring | No Marring |
| Dry Film Thickness [DFT; (mils)] | 3-4 | 3-4 |
| Flexibility (Conical mandrel) | ⅛ | Unmeasured |
| Impact Resistance (In · lb) | 160/160 | Unmeasured |
| Crosshatch Adhesion | 5B | 5B |
| Gloss | 6/35 | Unmeasured |
| PCI Smoothness | 6 | 5 |
| Storage Stability (40° C. for 7 | Pass | Pass |
| Days) | | |

The corrosion-resistant properties of the applied powder coating compositions were further tested for corrosive creep and crosshatch adhesion at each of 1000-hour and 1500-hour exposure times to salt fog for both electrostatically and non-electrostatically applied powder coating compositions. The average scribe creep and crosshatch adhesion for the electrostatically applied powder coating composition was 0.8 mm and 5B respectively for 1000 hours salt fog exposure, and 1.0 mm and 5B respectively for 1500 hours. The average scribe creep and crosshatch adhesion for the thermally spray applied powder coating composition was 0 mm and 5B for 1000 hours salt fog exposure and 0 mm and 5B respectively for 1500 hrs of salt fog exposure.

These results demonstrate the successful thermal spray application of the primer and how the thermally sprayed powder coating results in at least the same performance, if not better performance, than electrostatic applications, both relating to corrosion resistance and adhesion. Both the electrostatically applied and thermally spray applied coatings exhibited high corrosion resistance and strong bonding performance.

1. A powder coating composition comprising:
a polyamide-imide component comprising from 10 wt. % to 35 wt. % of the powder coating composition;
a catalyst; and
a carrier component, wherein each of the polyamide-imide component, the catalyst, and the carrier component react to form the powder coating composition.

2. The powder coating composition of claim 1, wherein the polyamide-imide component comprises from 20 wt. % to 30 wt. % of the powder coating composition.

3. The powder coating composition of claim 1, wherein the polyamide-imide component comprises an acid number of 80 or less.

4. The powder coating composition of claim 1, wherein the polyamide-imide component comprises an acid number of 20 or less.

5. The powder coating composition of claim 1, wherein the carrier component comprises an epoxide-containing component and a phenolic-containing component, the epoxide-containing component and the phenolic-containing component reactive to form an epoxy-phenolic reaction product.

6. The powder coating composition of claim 1, further comprising an adhesion promoter, the adhesion promoter further interacting with each of the polyamide-imide component, the catalyst, and the carrier component when forming the powder coating composition.

7. A method of preparing a coating composition comprising:
combining a polyamide-imide component, a catalyst, and a carrier component to form the coating composition;
extruding the coating composition at a temperature less than 100° C.; and
forming a powder of the coating composition.

8. The method of claim 7, wherein the coating composition is extruded at a temperature less than 85° C.

9. The method of claim 7, wherein an average particles size of the powdered coating composition is below 80 μm.

10. The method of claim 7, wherein the average particles size of the powdered coating composition is from 20 μm to 40 μm.

11. The method of claim 7, wherein the polyamide-imide component comprises from 20 wt. % to 30 wt. % of the powder coating composition.

12. The method of claim 7, wherein the polyamide-imide component has an acid number of 30 or less.

13. The method of claim 7, wherein the coating composition is a powder coating composition according to any one of claims 1 through 6

14. A coated article comprising:
a substrate;
a primer layer applied to the substrate in a spray application process, the primer layer comprising a polyamide-imide component, a phenolic component, a epoxy component, and a catalyst, wherein the polyamide-imide component interacts with each of the phenolic component, the epoxy component, and the catalyst when forming the primer layer; and
a topcoat layer applied to the primer layer wherein the primer layer and the topcoat layer bond to form a coating on the article.

15. The article of claim 14, wherein the primer layer at least partially cures ambiently, and the primer layer and the topcoat layer bond to form the coating.

16. The article of claim 14, wherein the primer layer is applied to a bare substrate.

17. The article of claim 14, wherein the substrate comprises at least one of a non-electrically conductive substrate, a plastic substrate, an electrically conductive substrate, and a metal substrate.

18.-20. (canceled)

21. The article of claim 14, wherein the primer layer is applied to the substrate in at least one of a thermal spray application process and an electrostatic spray application process.

22. (canceled)

23. The article of claim 14, wherein the primer layer is applied to the substrate at a thickness from 1 mil to 5 mils.

24. The article of claim 13, wherein the topcoat layer comprises a fluoropolymer and the fluoropolymer bonds with at least the polyamide-imide component of the primer layer when forming the coating.
